(19) United States
(12) Patent Application Publication
(10) Pub. No.: US 2014/0197089 A1
(43) Pub. Date: Jul. 17, 2014

(54) WATER FILTRATION KETTLE WITH A STERILIZATION FUNCTION

(71) Applicant: TIEN-CHI YAO, (US)

(72) Inventors: TIEN-CHI YAO, New Taipei (TW); SHIH-YI CHANG, Hsinchu (TW)

(73) Assignee: Tien-Chi Yao, New Taipei (TW)

(21) Appl. No.: 14/065,711

(22) Filed: Oct. 29, 2013

(30) Foreign Application Priority Data
Jan. 17, 2013 (TW) 102201083

(51) Int. Cl. C02F 1/32; C02F 1/28; C02F 1/00

(52) U.S. Cl. CPC C02F 1/325; C02F 1/003; C02F 1/28
USPC 210/251

(57) ABSTRACT

A water filtration kettle includes a container unit, a filtering unit, a bactericidal lamp and a power supply module. An interior of the container unit is provided with a water storage chamber and a water purification chamber which is disposed below the water storage chamber. A port is disposed between the water storage chamber and the water purification chamber, allowing the stored water to flow through. The filtering unit is disposed at the port of the container unit, and the bactericidal lamp is disposed at a side of the water purification chamber of the container unit. By the filtering function of the filtering unit and the sterilization function of the bactericidal lamp, the water filtration kettle is both provided with the filtering and sterilization function, allowing a user to consume the drinking water safely.

### BACKGROUND OF THE INVENTION

a) Field of the Invention

The present invention relates to a water filtration kettle, and more particularly to a water filtration kettle which is both provided with a filtering and sterilization function.

b) Description of the Prior Art

As the aggressive development and progression in industrial technologies, the standard of living has been improved continuously, along with people paying more attention to spending daily leisure time and eating healthily. However, the innovation of industrial technologies has been degrading our living environment day by day, and water, air, earth and foods that surround the current living environment have been contaminated to a certain degree. Therefore, how to eat healthily and consume the foods without worrying has become an issue for a modern person under the circumstance that our living environment is full of pollution.

In terms of water, the existing water sources are severely contaminated, wherein the turbidity of water, and the amounts of microorganisms (Escherichia coli and colony of bacteria) and heavy metal elements contained in the water are affected most. Therefore, to purify water, tap water is mostly added with chlorine for sanitizing and purification. Nevertheless, adding chlorine can only eliminate most of the microorganisms, but not the impurities and heavy metal elements, in the water. In addition, if there is too much chlorine in the water, the odor left in the water will make it undrinkable and drinking it may also endanger health.

Accordingly, the requirement to the drinking water is not just to satisfy the need of drinking, but also to pay more attention to cleanness and hygiene of the drinking water itself. Therefore, people will now use an RO (Reverse Osmosis) machine, a pure water machine, a water purifier or a water filter to filter the drinking water, so that they are able to drink pure, clean and safe water.

Although a conventional water filtration kettle is able to effectively eliminate the unclean impurities coming from water pipe lines and the traces of heavy metals in the water itself, this water filtration kettle is not very effective for the traces of viruses or microorganism left in the water.

Accordingly, a prior art has been shown up, as disclosed by the Taiwanese Patent Publication No. 201100334, “Water Purifier.” The water purifier includes a main unit, a purification unit, a purification pathway and ultraviolet light emitting diodes. The main unit is provided with a water outlet to discharge clean water, the purification unit is disposed in the main unit to purify raw water, the purification pathway is disposed between the purification unit and the water outlet, and the ultraviolet light emitting diodes are used to generate ultraviolet (UV) light. The UV light generated by the ultraviolet light emitting diodes irradiates in the purification pathway, along an extended direction of the purification pathway.

The abovementioned prior art utilizes the ultraviolet light emitting diodes that are much smaller than an ultraviolet lamp; thus, the water purifier does not have to be scaled up to keep the sterilization function. Furthermore, as the UV light irradiates generally along the flow direction of clean water after being purified by the purification unit, the sterilization can be implemented efficiently in a wider range. However, the ultraviolet light emitting diodes are not very powerful and the effect of sterilization is inferior as the clean water is irradiated at a same time when it is moving along the purification pathway.

### SUMMARY OF THE INVENTION

Accordingly, the primary object of the present invention is to provide a water filtration kettle that is both provided with a filtering and sterilization function.

To achieve the abovementioned object, the water filtration kettle of the present invention includes a container unit, a filtering unit, at least a bactericidal lamp, and a power supply module. An interior of the container unit is provided with a water storage chamber and a water purification chamber which is disposed below the water storage chamber. In addition, a port is disposed between the water storage chamber and the water purification chamber, allowing the stored water to flow through. The filtering unit is disposed at the port of the container unit and the bactericidal lamp is disposed at a side of the water purification chamber of the container unit. The bactericidal lamp can project a sterilization beam into the water purification chamber. The power supply module is disposed at a side of the container unit and is connected with the bactericidal lamp to provide electricity.

According to the abovementioned water filtration kettle, by the filtering function of the filtering unit and the sterilization function of the bactericidal lamp, the water filtration kettle is both provided with a filtering and sterilization effect, allowing a user to be able to consume drinking water safely. Besides that, the power supply module is disposed at a side of the container unit to facilitate the user to operate the water filtration kettle.

To achieve the abovementioned object, the bactericidal lamp is disposed transversally in the water purification chamber close to a bottom or is disposed in the water purification chamber opposite to a bottom of the filtering unit.

To achieve the abovementioned object, the bactericidal lamp is further provided with a lamp shade.

An outer surface of the lamp shade is provided with a metal screen; or the outer surface of the lamp shade is provided with a photocatalyst layer; or the outer surface of the lamp shade is provided with the metal screen, whereas an outer surface of the metal screen is covered by the photocatalyst layer.

To achieve the abovementioned object, the power supply module is provided with a power unit, and the power unit can be a permanent battery or a rechargeable battery.

To achieve the abovementioned object, the bactericidal lamp can be a cold cathode tube.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a three-dimensional structural view of a first embodiment of a water filtration kettle, according to the present invention.

FIG. 2 shows a structural schematic view of the first embodiment of the water filtration kettle, according to the present invention.

FIG. 3 shows a three-dimensional structural view of a second embodiment of the water filtration kettle, according to the present invention.

FIG. 4 shows a structural schematic view of a bactericidal lamp, according to the present invention.

FIG. 5 shows a structural schematic view of another embodiment of the bactericidal lamp, according to the present invention.

FIG. 6 shows a structural schematic view of still another embodiment of the bactericidal lamp, according to the present invention.

### DETAILED DESCRIPTION OF THE PREFERRED EMBODIMENTS

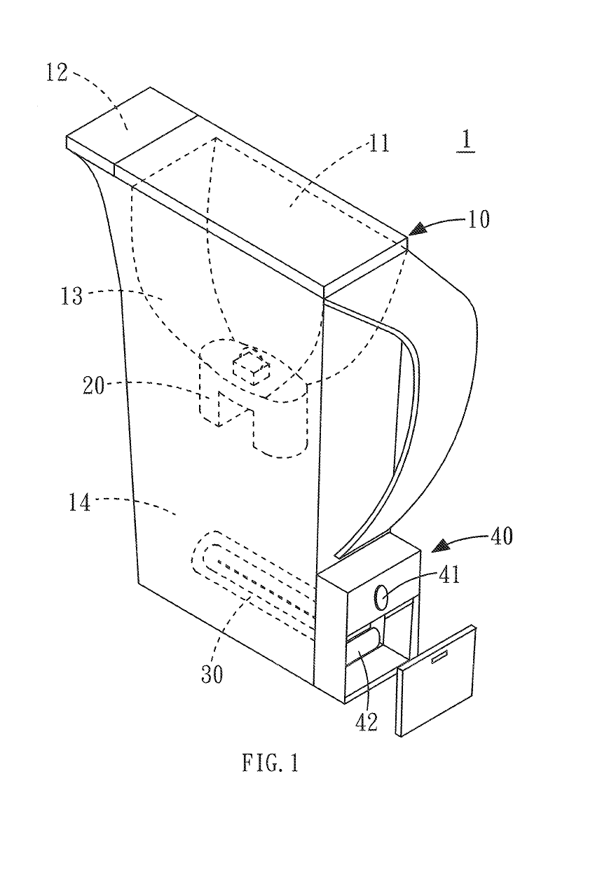

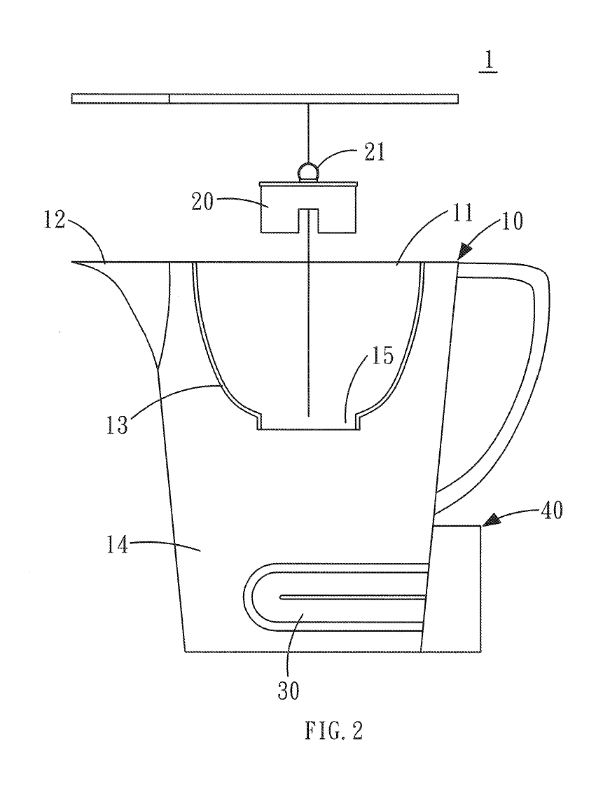

FIG. 1 discloses a three-dimensional structural view of a first embodiment of a water filtration kettle, according to the present invention. FIG. 2 shows a structural schematic view of the first embodiment of the water filtration kettle, according to the present invention. The water filtration kettle 1 comprises a container unit 10, a filtering unit 20, at least a bactericidal lamp 30 and a power supply module 40.

The container unit 10 is provided with a water inlet 11 and a water outlet 12. An interior of the container unit 10 defines a water storage chamber 13 and a water purification chamber 14 which is disposed below the water storage chamber 13. The water inlet 11 is connected with the water storage chamber 13, and the water outlet 12 is connected with the water purification chamber 14. In addition, a port 15 is disposed between the water storage chamber 13 and the water purification chamber 14, allowing the stored water to flow through.

The filtering unit 20 is disposed at the port 15 of the container unit 10, and the water that is stored in the water storage chamber 13 can flow into the water purification chamber 14, with impurities of the water being filtered by the filtering unit 20. An interior of the filtering unit 20 is provided with a filtering material to filter and adsorb the impurities of drinking water that flows in from the water storage chamber 13, thereby achieving a pre-filtering effect before the drinking water reaches to the water purification chamber 14. Furthermore, a top of the filtering unit 20 is provided with a pull ring 21, facilitating a user to separate the filtering unit 20 from the container unit 10 in order to replace the filtering unit 20.

The bactericidal lamp 30 is disposed at a side of the water purification chamber 14 of the container unit 10 and is able to project a sterilization beam into the water purification chamber 14. As shown in the drawings, the bactericidal lamp 30 is disposed transversally in the water purification chamber 14 close to a bottom, and can be a cold cathode tube which releases a UV light beam at a wavelength of about 250-260 nm.

The power supply module 40 is disposed at a side of the container unit 10 and is connected with the bactericidal lamp 30 to provide electricity. The power supply module 40 is provided with a control switch 41 and at least a power unit 42. The control switch 41 is connected with the power unit 42 and is able to control the power unit 42 to provide electricity. The power unit 42 can be a permanent battery or a rechargeable battery.

When the user is to utilize the water filtration kettle, he or she first pours drinking water into the water storage chamber 13 from the water inlet 11, allowing the impurities of drinking water to be filtered and adsorbed by the filtering unit 20. Next, the filtered drinking water will flow into the water purification chamber 14 for sterilization by a UV light beam released from the bactericidal lamp 30 in the water purification chamber 14. Therefore, the water filtration kettle is both provided with the filtering and sterilization effect, so that the user is able to consume the drinking water in the container unit 10 more safely. On the other hand, the control switch 41 can be used to turn on the bactericidal lamp 30 for at least 30 seconds to actually achieve the better sterilization effect.

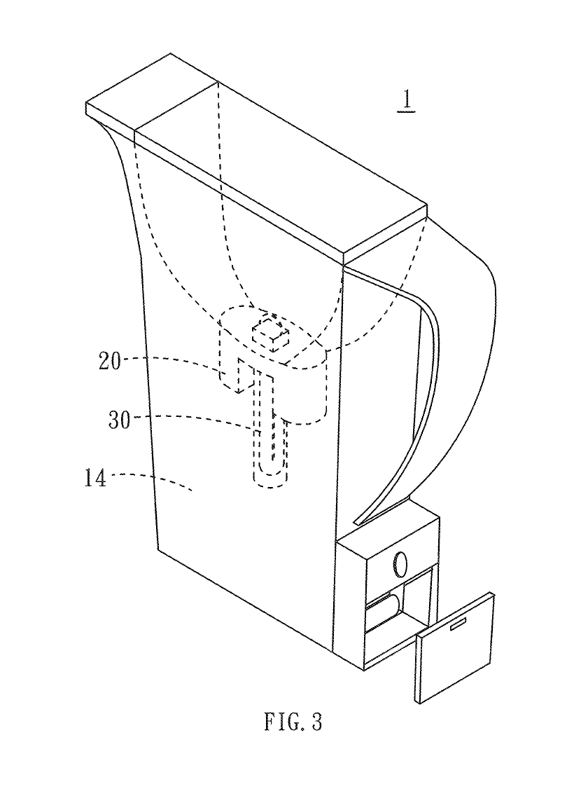

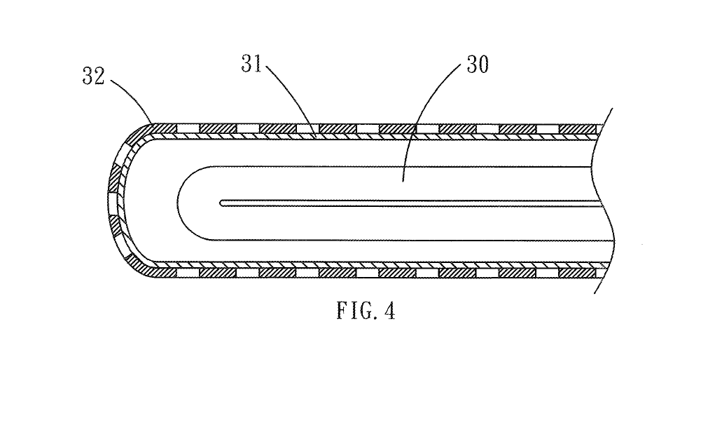

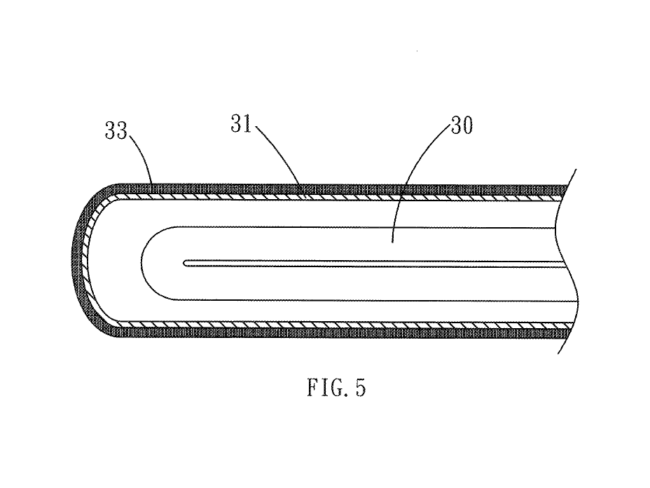

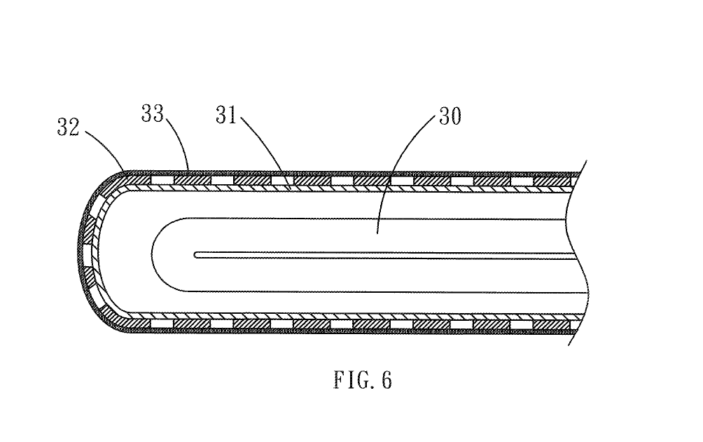

Furthermore, as shown in FIG. 3, in the second embodiment, the bactericidal lamp 30 can be also disposed in the water purification chamber 14 opposite to a bottom of the filtering unit 20, and the bactericidal lamp 30 can be further provided with a lamp shade 31 for protection, as shown in FIG. 4. In addition, an outer surface of the lamp shade 31 is further provided with a metal screen 32. Or, the outer surface of the lamp shade 31 is covered by a photocatalyst layer 33, as shown in another embodiment in FIG. 5. Or, the outer surface of the lamp shade 31 is provided with the metal screen 32, and the an outer surface of the metal screen 32 is covered by the photocatalyst layer 33, as shown in still another embodiment in FIG. 6. Light released from the bactericidal lamp 30 can irradiate directly on the photocatalyst layer 33 to excite the photocatalyst material, which generates negative ions to increase the sterilization effect.

It is worthy of mentioning that the present invention is provided with following advantages as compared to the prior art:
1. The water filtration kettle is both provided with the filtering and sterilization effect.
2. The bactericidal lamp is disposed in the water purification chamber to project the sterilization beam to the drinking water that stays in the water purification chamber. Therefore, the sterilization effect is better.
3. The power supply module is disposed at a side of the container unit, which facilitates the user to operate the water filtration kettle.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A water filtration kettle with a sterilization function, comprising:
a container unit, the container unit is provided with a water inlet and a water outlet, and an interior of the container unit defines a water storage chamber and a water purification chamber which is disposed below the water storage chamber, with that the water inlet is connected with the water storage chamber, the water outlet is connected with the water purification chamber, and a port is disposed between the water storage chamber and the water purification chamber, allowing the stored water to flow through;
a filtering unit, the filtering unit is disposed at the port of the container unit, allowing the water that is stored in the water storage chamber to flow into the water purification chamber and impurities of the stored water to be filtered;
a bactericidal lamp, the bactericidal lamp is disposed at a side of the water purification chamber of the container unit and projects a sterilization beam in the water purification chamber; and
a power supply module, the power supply module is disposed at a side of the container unit and is connected with the bactericidal lamp to provide electricity, with that the power supply module is provided with a control switch and a power unit, and the control switch is connected with the power unit to control the power unit to provide electricity.

2. The water filtration kettle with a sterilization function, according to claim 1, wherein the bactericidal lamp is disposed transversally in the water purification chamber close to a bottom.

3. The water filtration kettle with a sterilization function, according to claim 2, wherein the bactericidal lamp is further provided with a lamp shade.

4. The water filtration kettle with a sterilization function, according to claim 3, wherein an outer surface of the lamp shade is provided with a metal screen.

5. The water filtration kettle with a sterilization function, according to claim 3, wherein an outer surface of the lamp shade is provided with a photocatalyst layer.

6. The water filtration kettle with a sterilization function, according to claim 3, wherein an outer surface of the lamp shade is provided with a metal screen, and an outer surface of the metal screen is covered by a photocatalyst layer.

7. The water filtration kettle with a sterilization function, according to claim 2, wherein the power unit is a permanent battery or a rechargeable battery.

8. The water filtration kettle with a sterilization function, according to claim 2, wherein the bactericidal lamp is a cold cathode tube.

9. The water filtration kettle with a sterilization function, according to claim 1, wherein the bactericidal lamp is disposed in the water purification chamber opposite to a bottom of the filtering unit.

10. The water filtration kettle with a sterilization function, according to claim 9, wherein the bactericidal lamp is further provided with a lamp shade.

11. The water filtration kettle with a sterilization function, according to claim 10, wherein an outer surface of the lamp shade is provided with a metal screen.

12. The water filtration kettle with a sterilization function, according to claim 10, wherein an outer surface of the lamp shade is provided with a photocatalyst layer.

13. The water filtration kettle with a sterilization function, according to claim 10, wherein an outer surface of the lamp shade is provided with a metal screen, and an outer surface of the metal screen is covered by a photocatalyst layer.

14. The water filtration kettle with a sterilization function, according to claim 9, wherein the power unit is a permanent battery or a rechargeable battery.

15. The water filtration kettle with a sterilization function, according to claim 9, wherein the bactericidal lamp is a cold cathode tube.

16. The water filtration kettle with a sterilization function, according to claim 1, wherein the bactericidal lamp is further provided with a lamp shade.

17. The water filtration kettle with a sterilization function, according to claim 16, wherein an outer surface of the lamp shade is provided with a metal screen.

18. The water filtration kettle with a sterilization function, according to claim 16, wherein an outer surface of the lamp shade is covered by a photocatalyst layer.

19. The water filtration kettle with a sterilization function, according to claim 16, wherein an outer surface of the lamp shade is provided with a metal screen, and an outer surface of the metal screen is covered by a photocatalyst layer.
